(19) United States
(12) Patent Application Publication
(10) Pub. No.: US 2010/0078298 A1
(43) Pub. Date: Apr. 1, 2010

(54) Interlocking Lock for Preventing a Switch from Switching On

(75) Inventors: Karsten Freundt, Falkensee (DE); Karl-Heinz Voss, Dallgow-Doberitz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/063,505

(22) PCT Filed: Jul. 21, 2006
(86) PCT No.: PCT/EP2006/064509

§ 371 Date: Feb. 11, 2008

(30) Foreign Application Priority Data
Aug. 10, 2005 (DE) 10 2005 038 629.6

(51) Int. Cl. H01H 9/28

(52) U.S. Cl. 200/43.18

(57) ABSTRACT

A locking mechanism in a switch in the field of electrical power distribution prevents an energy storage device from being discharged. The mechanism has a pushbutton which, when the locking mechanism is in an unlocked position, is coupled by way of a force transmission element via an interlocking connection to a discharge initiator for discharging of the energy storage device, such that a switching-on movement acting on the pushbutton is introduced via the force transmission element into the discharge initiator in order to relieve the load on a force storage device, with the force transmission element being connected to interlock interruption means for moving the locking mechanism to a locked position in which the interlock is cancelled. The pushbutton and the force transmission element are guided in the unlocked position to move in a common longitudinal direction, such that a pushing movement of the pushbutton is introduced into the switching-on initiator via a longitudinal movement of the force transmission element. The locking mechanism is mechanically compact and operates reliably. The force transmission element is pivotally mounted such that, in a locked position, a movement direction of the force transmission element is aligned at an angle to the pushing movement of the pushbutton, with the interlock interruption means being coupled to a drive shaft of the switch and/or to an auxiliary switch.

The invention relates to a locking mechanism for preventing the discharge of an energy store in a switch in the sector of electrical energy distribution, with a pushbutton, which is coupled in an unlocking position of the locking mechanism by means of a force transmission element to a discharge triggering device for discharging the energy store via an interlocking connection, so that a switch-on movement acting on the pushbutton can be introduced into the discharge triggering device via the force transmission element in order to relieve the energy store of tension, the force transmission element being connected to interlocking-connection interruption means, which are designed to move the locking mechanism over to a locking position, in which the interlocking connection is canceled, the pushbutton and the force transmission element in the unlocking position being guided movably in a common longitudinal direction, so that a thrusting movement of the pushbutton can be introduced into the switch-on triggering device via a longitudinal movement of the force transmission element.

Such a locking mechanism is already known from DE 44 39 751 C2. The locking mechanism described therein has a pushbutton, with a pin protrusion, which bears laterally with its free end in an unlocking position against the end region of a bar-shaped stopper. The stopper in addition bears with its side remote from the pushbutton against a lever protrusion of a half-shaft, which prevents the discharge of a force store by virtue of the fact that it is arranged on a path which a switch-on catch needs to cover when the force store is discharged. The stopper is mounted such that it can swivel, with the result that a thrusting movement of the pushbutton is introduced into the half-shaft as a rotary movement via the stopper and the protrusion. As a result of the rotation of the half-shaft, the latter is aligned with respect to the switch-on catch in such a way that it makes it possible for the tension on the force store to be relieved. In order to prevent the tension on the force store from being relieved via the pushbutton, the stopper is guided in such a way that it is longitudinally movable and can be removed from the train of the mechanical force transmission, so that a thrusting movement of the pushbutton can no longer have an interlocking effect on the protrusion of the half-shaft. In other words, the interlocking connection between the pushbutton and the discharge triggering device, namely the half-shaft, is canceled. The previously known locking mechanism is associated with the disadvantage that the stopper can both be displaced in a longitudinal direction, but also is mounted in articulated fashion. Firstly, the canceling of the interlocking connection via a linear movement is mechanically complicated. Furthermore, the articulated suspension makes reinsertion of the stopper between the pushbutton and protrusion with a precise fit more difficult, with the result that additional guide means are required.

DE 43 33 828 C1 describes the control mechanism from DE 44 39 751 C2 in a slightly modified, more detailed way. Thus, this document also discloses a pushbutton which is guided such that it is longitudinally movable and whose thrusting movement can be introduced into a discharge triggering device via a force transmission element. The discharge triggering device is again in the form of a half-shaft. The half-shaft in an unlocked position of the locking mechanism lies on the path which is covered by a switch-on catch when the tension of a force store is relieved. The force transmission means comprise an angle lever, which has a first bearing, acted upon by the pushbutton, and a second bearing, which is connected in articulated fashion to a coupling rod. The coupling rod has a coupling journal, which in an unlocking position bears against a driver journal of the protrusion of the half-shaft. A coupling shaft, which is connected to the coupling rod of the force transmission element via a coupling lever, is used for canceling the interlocking connection between the force transmission element and the discharge triggering device. As a result of a rotation of the coupling shaft, the interlocking connection between the force transmission element and the half-shaft or in other words between the force transmission element and the discharge triggering device is canceled, so that the train of the mechanical arrangement is interrupted. The previously known configuration of the force transmission element is complex and cost-intensive, however.

The object of the invention is therefore to provide a locking mechanism of the type mentioned at the outset which is mechanically compact and functions in a reliable manner.

The invention achieves this object by virtue of the fact that the force transmission element is mounted such that it can swivel, so that, in a locking position, a moving direction of the force transmission element is aligned at an angle to the thrusting movement of the pushbutton, the interlocking-connection interruption means being coupled to a drive shaft of the switch and/or to a secondary switch.

In accordance with the invention, the force transmission element is not guided such that it is longitudinally movable, but can be removed reliably from the interlocking connection between the pushbutton and the tension-relief triggering device by introducing a rotary movement. Furthermore, large linear movements are avoided, so that the locking mechanism is both reliable and compact.

Advantageously, the interlocking-connection interruption means have an angle lever, which is articulated on a pivot, which is fixed in position, and is coupled to a restoring spring at a restoring bearing and is coupled to the force transmission element at a connecting bearing by means of a swiveling lever. In accordance with this expedient development, the movement for swiveling the force transmission element is introduced via an angle lever, as a result of which a multifunctional and at the same time compact locking mechanism is provided.

In accordance with an expedient development in this regard, the angle lever is coupled to a switching shaft of the secondary switch by means of lever kinematics in such a way that, if the secondary switch is in a disconnecting position, the angle lever is swiveled counter to the spring force of a restoring spring and the force transmission element is moved over from the unlocking position into the locking position. In this way, the secondary switch, which is, for example, a switch disconnector, can be coupled to the locking mechanism, so that, if the secondary switch is located in a disconnecting position, it is made impossible for the force store to be discharged and therefore for the switch, which is, for example, a circuit breaker, to be connected. The coupling between the force transmission element and the secondary switch takes place via expedient lever kinematics and via the angle lever already described. In this case, the force transmission element is mechanically coupled to the drive spindle of the secondary switch. Undesired tripping of the switch, such as of a circuit breaker, for example, in the event of an open secondary switch, i.e. one which is located in the disconnecting position, which secondary switch is in the form of a switch disconnector, for example, is thus avoided.

In accordance with an advantageous development of the invention, the angle lever is coupled to a withdrawable-part lock of a withdrawable part by means of lever kinematics in such a way that, if the switch is displaced on the withdrawable part out of a contact position, the angle lever is swiveled counter to the spring force of the restoring spring and the force transmission element is moved over from the unlocking position into the locking position. In accordance with this development of the invention, the lever kinematics are coupled to a withdrawable-part lock. However, the displacement of a switch on a withdrawable part has, in particular in the case of air-insulated switches, the same effect as a separate secondary switch, with the result that the displacement on the withdrawable-part guide is in this case equivalent to the opening of the contacts of a secondary switch and therefore to the coupling to a secondary switch. During the displacement of the switch, for example, contacts which are fixedly connected to the switch are disconnected from contacts which are fixedly mounted on a switchgear assembly. In this case, the switch is mounted movably in the switchgear assembly by means of the withdrawable part.

In accordance with a further expedient development, the angle lever has a driver pin, which extends in a slot of a drive lever, the drive lever at its end remote from the slot being fastened on a cam disk, which is connected to a drive shaft of the switch in such a way that it is fixed against rotation, with the result that, in a switch-on position of the drive shaft, the angle lever is swiveled so as to cancel the interlocking connection between the pushbutton and the discharge triggering device. In accordance with this advantageous development, the angle lever and therefore the force transmission element can be coupled to the position of the drive shaft of the switch, with the result that discharging of the force store is made impossible if the contacts of the switch are already located in a contact position. In such a case, no-load switching operations would be triggered, the energy of the force store no longer being converted into kinetic energy of the switching mechanism. The switching mechanism is severely loaded by these no-load switching operations, however. It is of course also possible for the angle lever both to be coupled to the switching shaft of the switch or circuit breaker via the drive lever and to be coupled to the secondary switch and/or switch disconnector or else to the lock of a withdrawable part via expedient lever kinematics. The term switch disconnector in such a case also includes a plurality of individual switch disconnectors connected in series. The slot of the drive lever is used for mechanically disconnecting the lock which is triggered by a secondary switch and the lock which is brought about by the switching position of the switch shaft.

Further expedient configurations and advantages of the invention are the subject matter of the description below relating to exemplary embodiments of the invention with reference to the figures in the drawing, in which functionally identical component parts have been provided with the same reference symbols and in which:

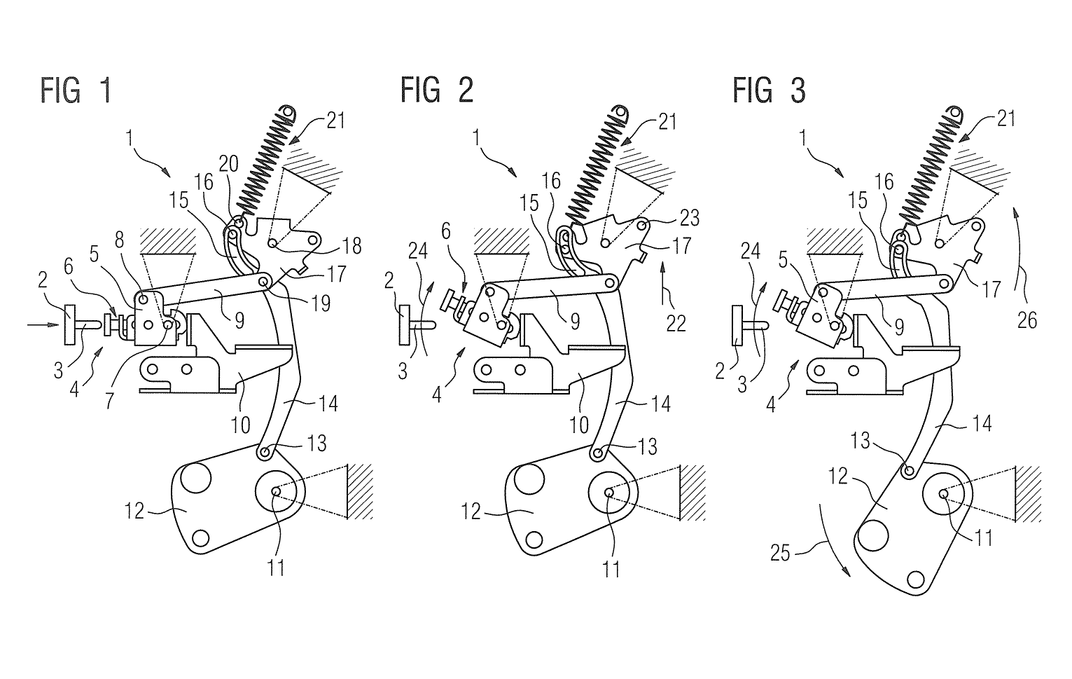

FIG. 1 shows a schematic illustration of an exemplary embodiment of the locking mechanism according to the invention in an unlocking position,

FIG. 2 shows the locking mechanism shown in FIG. 1 in a locking position, and

FIG. 3 shows the locking mechanism shown in FIG. 1 in a further locking position.

FIG. 1 shows an exemplary embodiment of the locking mechanism 1 according to the invention in a schematic illustration. The locking mechanism 1 has a pushbutton 2, which bears with its pin extension 3 against a force transmission element 4. The force transmission element 4 has a guide frame 5, in which a displacement element 6 is guided movably in a linear movement direction. The guide frame 5 is held movably about a swivel bearing 7, which is fixed in position, and is connected to a swiveling lever 9 at a bearing 8.

The force transmission element 4 in the unlocking position shown in FIG. 1 bears with its longitudinally movable displacement element against a discharge triggering device 10, which, on actuation, i.e. as a result of the introduction of a thrusting movement in the arrow direction shown into the discharge triggering device 10, releases a lock of an energy store (not illustrated in the figures), with the result that the energy store is discharged.

The energy store in the exemplary embodiment shown is mechanically coupled to a drive shaft 11, which is held fixed in position and such that it can rotate by bearings (not shown). The introduction of a rotary movement into the drive shaft 11 moves the switching contacts of a circuit breaker over from a contact position, in which the switching contacts of the switch bear against one another, into a disconnecting position, in which the contacts of the switch are disconnected from one another or from the disconnecting position into the contact position.

In this case, the drive shaft 11 is expediently connected to three switch poles, each switch pole having a few contacts. The drive shaft 11 is in this case connected to a cam disk 12 in such a way that it is fixed against rotation, which cam disk 12 is in turn connected in articulated fashion to a swiveling drive lever 14 at a cam disk bearing 13. The swiveling drive lever 14 has, at its end remote from the cam disk bearing 13, a slot 15, into which a driver pin 16 of an angle lever 17 extends, which angle lever is capable of moving about a pivot bearing 18, which is fixed in position. The angle lever 17 is connected in articulated fashion to the swiveling lever 9 at its bearing 19. In addition, at the restoring spring bearing 20, the angle lever 17 is coupled to a restoring spring 21, which, in the position shown, holds the driver 16 of the angle lever 17 at the upper end of the slot 15. The upper limit of the slot 15 therefore forms a type of abutment.

FIG. 2 shows the locking mechanism shown in FIG. 1 in a locking position, in which the circuit breaker has been displaced on a withdrawable part so as to disconnect contacts of a switch disconnector. As a deviation from this, the angle lever 17 is coupled to the drive shaft of a separate switch disconnector or secondary switch which is not shown. It is of course also possible for both variants to be realized jointly in the context of the invention.

The movement, which is necessarily introduced, for example for the purpose of displacing the switch on the withdrawable-part guide, is introduced into the angle lever 17 via a lever mechanism (not illustrated in FIG. 2), which angle lever 17 then moves in the arrow direction 22 shown. The lever mechanism is linked to a bearing 23 of the angle lever 17, for example. As a result of the connection between the angle lever 17 and the force transmission element 4 via the swiveling lever 9, swiveling of the force transmission element 4 occurs in a direction indicated by the arrow 24. The movement direction of the displacement element 6 of the force transmission element 4 is therefore aligned at an angle to the movement direction of the pushbutton 2, in which the pin extension 3 of the pushbutton 2 extends. In this way, the switch-on movement of the pushbutton 2 can no longer be transmitted to the discharge triggering device 10, so that discharging of the force store is made impossible.

FIG. 3 shows the locking mechanism shown in FIG. 1 in a further unlocking position, the unlocking position having been brought about by a movement of the drive shaft 11. A rotation of the drive shaft 11 brings about a rotation of the cam disk 12, which is connected thereto in a manner fixed against rotation, in the arrow direction 25 shown and therefore a downward displacement of the swiveling drive lever 14. The driver 16 of the angle lever 17 which protrudes into the slot 15 of the swiveling drive lever 14 is in this way likewise moved downwards, with the result that the angle lever 17 is swiveled in the arrow direction 26 shown. As a result of the lever connection 9 between the guide frame 5 and the angle lever 17, the force transmission element 4 is likewise swiveled in the arrow direction 24. As a result of the rotation of the drive shaft 11, therefore not only the switching contacts of the switch poles of the switch but furthermore also a locking position of the locking mechanism are brought about, in which position the tension of the energy store (not shown) is prevented from being relieved by actuation of the pushbutton 2.

1-5. (canceled)

6. A locking mechanism for preventing a discharge of an energy storage device in a switch of an electrical energy distribution system, the locking mechanism comprising:
a pushbutton and a force transmission element, said force transmission element, in an unlocking position of the locking mechanism, coupling said pushbutton via an interlocking connection to a discharge triggering device for discharging the energy storage device;
wherein a switch-on movement acting on said pushbutton is introduced into the discharge triggering device via said force transmission element in order to relieve a force storage device of tension;
interlocking-connection interruption means connected to said force transmission element, said interlocking-connection interruption means being configured to move the locking mechanism into a locking position, in which said interlocking connection is canceled, said pushbutton and said force transmission element, in an unlocking position, being movably guided in a common longitudinal direction, such that a thrusting movement of said pushbutton is introduced into the discharge triggering device via a longitudinal movement of said force transmission element;
said force transmission element being pivotally mounted, wherein, in a locking position, a moving direction of said force transmission element is skewed at an angle to the thrusting movement of said pushbutton; and
wherein said interlocking-connection interruption means are coupled to at least one of a drive shaft of the switch and a secondary switch.

7. The locking mechanism according to claim 6, wherein said interlocking-connection interruption means include an angle lever, which is articulated on a positionally fixed pivot, and is coupled to a restoring spring at a restoring bearing and is coupled to said force transmission element at a connecting bearing by way of a swiveling lever.

8. The locking mechanism according to claim 7, wherein said angle lever is coupled to a switching shaft of the secondary switch by way of lever kinematics such that, if the secondary switch is in a disconnecting position, said angle lever is swiveled counter to a spring force of said restoring spring and said force transmission element is moved from the unlocking position into the locking position.

9. The locking mechanism according to claim 7, wherein said angle lever is coupled to a withdrawable-part lock of a withdrawable part by way of lever kinematics such that, if the switch is displaced on said withdrawable part, said angle lever is swiveled counter to a spring force of said restoring spring and said force transmission element is moved from the unlocking position into the locking position.

10. The locking mechanism according to claim 7, wherein said angle lever has a driver pin extending in a slot of a drive lever, said drive lever has an end remote from said slot fastened on a cam disk, which is connected to said drive shaft of the switch such that it is fixed against rotation, whereby, in a switch-on position of said drive shaft, said angle lever is swiveled so as to cancel the interlocking connection between said pushbutton and said discharge triggering device.
